(19) United States
(12) Patent Application Publication
(10) Pub. No.: US 2002/0176141 A1
(43) Pub. Date: Nov. 28, 2002

(54) Method and apparatus for optical data transmission

(76) Inventors: Melih Ogmen, Ariss (CA); Richard Adair, Waterloo (CA)

Correspondence Address: Orange & Chari, Suite 4900, P.O. Box 190, 66 Wellington Street West, Toronto, ON, M5K 1H6, CA

(21) Appl. No.: 10/034,205

(22) Filed: Jan. 3, 2002

(30) Foreign Application Priority Data
Jan. 3, 2001 (CA) 2,330,195

(51) Int. Cl. H04B 10/12; H04B 10/04

(52) U.S. Cl. 359/173; 359/188

(57) ABSTRACT

A method of transmitting data over a fiber-optic channel, where the data comprises multi-valued bits each having at least three possible values. The method comprises establishing a respective optical characteristic corresponding to each of the possible values. For each multi-valued bit of the data, a pulse is transmitted having the optical characteristic corresponding to the value of the multi-valued bit.

### BACKGROUND OF THE INVENTION

1. Field of the Invention

The present invention relates to optical data transmission over a fibre-optic cable and connections.

2. Description of the Prior Art

The wide spread use of dual valued or binary logic and the historic definition of a bit is largely due to the successful development and subsequent mass production of solid state devices such as transistors and associated microelectronic components. These devices have two stable, well-defined states and hence lend themselves readily to the use of dual valued logic both in coding and transmission of information.

The two states of a bit were originally identified as state “1” denoting existence of electric potential at a given point and the state “0” as not having the said potential at that point. The use of the binary logic requires information to be defined as strings of binary digits of arbitrary length known as bytes or words. Thus an increase in the amount of information to be transferred per unit time requires an increase in the number of digits transferred. A conventional 8-bit byte has 256 distinct values since each bit has only two distinct states. The number of distinct combinations increases dramatically when the number of bits is increased. A 16-bit word, i.e. two bytes, has 65,536 possible values and a 32-bit word, i.e. four bytes, has 4,294,967,296 possible values.

Fibre-optic data transmission works by sending pulses of light from a laser over a fibre. The laser receives binary data from a source, and sends the data over the fibre one bit at a time. When the bit is 1, a laser pulse is sent, and when the bit is 0, no pulse is sent. The pulse rate of the laser and the minimum resolvable laser pulse width determine the transmission speed through a given fibre. The fibre cable may have multiple strands, with the strands forming individual communication channels.

Fibre-optic networks have an ever-increasing need for capacity to carry voice, data, and multimedia traffic. The simplest way to increase capacity is to provide more fibres, and to allocate one fibre for each use. However, this requires physically laying the new cables, which is often expensive and difficult to do. The cables may be under the ocean, or in a densely populated city, or they may simply be very long cables through rural areas. In each case, laying new cable is an involved process.

Accordingly, it is of interest to increase the transmission speed over fibre-optic cables. Various solutions are in use to increase the amount of data that can be transferred over one strand of fibre. One technique is known as Dense Wavelength Division Multiplexing (DWDM). With DWDM encoding, a number of channels are established in the fibre-optic cable for data transmission, each corresponding to a wavelength of light. DWDM encoding is often described by considering each channel as a colour. At the transmission end, multiple colours are merged together to form one light beam, and at the other end, the light beam is refracted into the colours to split up the channels. Even though the channels are merged for transmission over a single fibre strand, the channels are completely separate from each other, and accordingly can use different transmission speeds and data formats from each other. Each channel transmits binary data represented as a group of bits. Since a bit is a very small unit of information, many bits must be used in order to transmit any substantial amount of information.

The temporal duration of each pulse is limited by the the minimum resolvable laser pulse width and accordingly increased transmission rates requires either increased resoloution or increased channels.

It is an object of the present invention to obviate or mitigate at least some of the above disadvantages.

### SUMMARY OF THE INVENTION

In accordance with one aspect of the present invention, there is provided a method of transmitting data over a fibre-optic channel, where the data comprises a string of multi-valued bits each having one of at least three possible values. The method comprises establishing a respective optical characteristic corresponding to each of the possible values. For each multi-valued bit of the data, a pulse is transmitted having the optical characteristic corresponding to the value of the multi-valued bit.

### BRIEF DESCRIPTION OF THE DRAWINGS

These and other features of the preferred embodiments of the invention will become more apparent in the following detailed description in which reference is made to the appended drawings wherein:

FIG. 1 is a schematic representation of a fibre-optic communication system.

FIG. 2 is a more detailed schematic representation of the data source of FIG. 1.

FIG. 2a is a more detailed schematic representation of the optical encoder of FIG. 1.

FIG. 3 is a schematic representation of the data encoding of FIG. 1.

FIG. 3a is a schematic representation of laser pulses sent in FIG. 1.

FIG. 4 is a schematic representation of a preferred embodiment of the optical encoder.

FIG. 4a is a schematic representation of the data encoding of FIG. 4.

FIG. 4b is a schematic representation of laser pulses sent in FIG. 4.

FIG. 4c is an enlarged view of a laser pulse of FIG. 4b.

FIG. 5 is a schematic representation of another embodiment of the optical encoder shown in FIG. 4.

FIG. 6 is a schematic representation of yet another embodiment of the optical encoder shown in FIG. 4.

FIG. 7 is a schematic representation of still another embodiment of the optical encoder shown in FIG. 4.

FIG. 8 is a schematic representation of a base converter.

FIG. 9 is a schematic representation of another embodiment of the base converter of FIG. 8.

FIG. 10 is a more detailed view of the base converter of FIGS. 9 and 10.

FIG. 11 is a schematic representation of a further embodiment.

### DESCRIPTION OF THE PREFERRED EMBODIMENTS

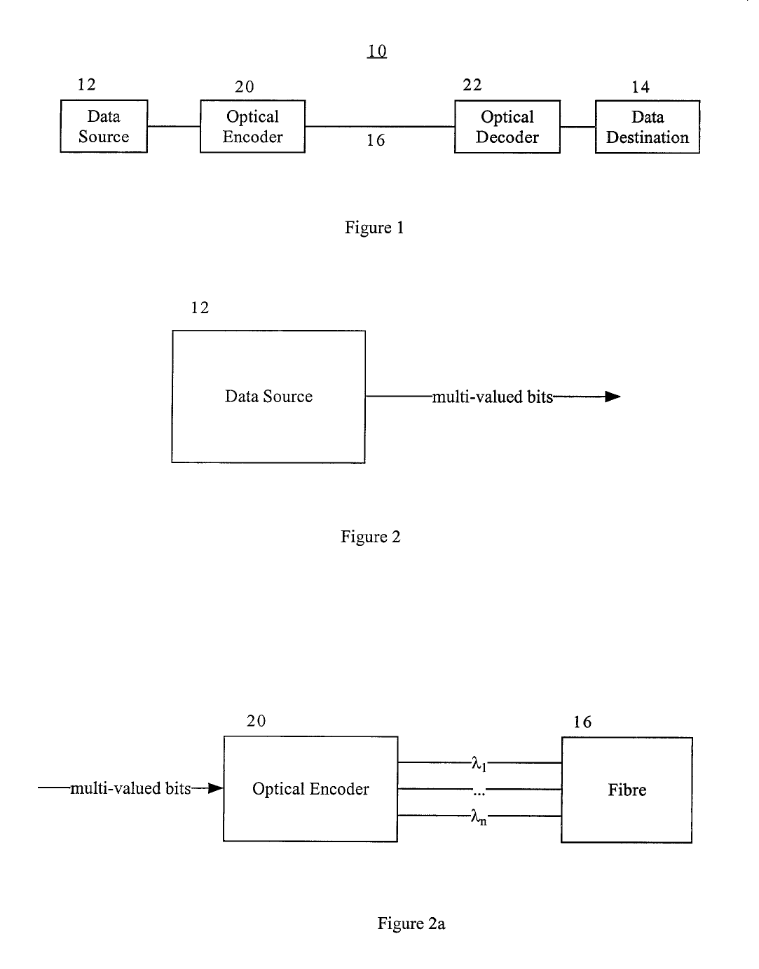

Referring to FIG. 1, a fibre-optic communication system is shown generally by the numeral 10. The system comprises a data source 12, a data destination 14, and a fibre communication link 16. An optical encoder 20 is provided to receive data from the source 12 and convert it to an optical signal, and an optical decoder 22 is provided at the destination 14 to receive optical data and convert it to a form usable by the destination 14. The data source 12 transfers data to the optical encoder 20. The optical encoder 20 sends the data over the fibre 16, after processing the data as described more fully below. The optical decoder 22 receives the data transmitted over the fibre 16 and processes the data, as described more fully below. Finally, the optical decoder 22 sends the processed data to the data destination 14. It will be appreciated that the system may be bi-directional with the destination functioning as a source and the source as a destination but for clarity of explanation a single direction of transmission will be assumed.

In order to effect more efficient communication, a multi-valued bit scheme is used. The applicants have recognized that with the advent of laser based fibre optic communications technology there is no underlying reason to adhere to the earlier definition of a bit since lasers can emit at many different wavelengths with varying intensities, polarizations, and numerous other optical characteristics. Each bit is defined as an entity with a depth characteristic. Under this definition, a conventional bit depth is 1. A multi-valued bit can have a depth of any integer number, which is advantageously more than 2. The depth of a multi-valued bit will be limited not by theoretical boundaries but technological and economical factors.

This change in the basic concept of definition of a bit from a conventional to a multi-valued bit, has an enormous effect on the information that can be carried within communication networks, computers and other devices that need to interact with each other.

In a multi-valued bit with more then two intrinsic states, the number of distinct combinations that can be achieved per unit of information increases exponentially. For example in a multi-valued bit with four possible states, an 8-bit byte will have 65,536 possible values and a 32-bit word will have 18,446,744,073,709,551,616 distinct values. For a 32-bit communication block, a small change in the available states from two to four translates into an increase by a factor of approximately 4.3 billion in the number of distinct combinations available.

Referring therefore to FIGS. 2 and 2a, the data source 12 provides a string of multi-valued bits to the optical encoder 20. Each multi-valued bit has n possible values, referred to as 1 through n. Each possible value is assigned to a respective wavelength λ₁, . . . , λₙ. The optical encoder 20 transmits a pulse at the appropriate wavelength for each multi-valued bit. The pulses travel over the fibre 16 to the optical decoder. The optical decoder 22 determines the wavelength of the laser pulse and sends the corresponding multi-valued bit to the data destination 14.

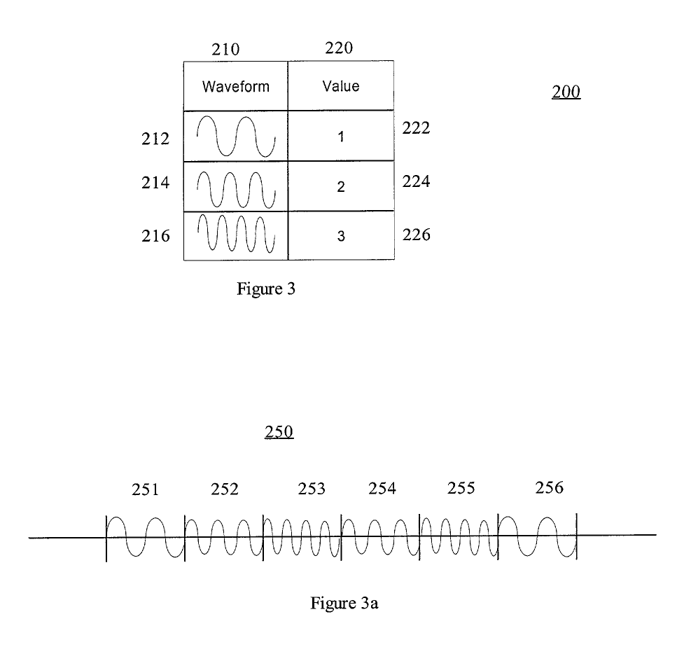

Referring to FIGS. 3 and 3a, the nature of the encoding performed by the optical encoder 20 is shown. Referring to FIG. 3, a waveform 210 is associated with each value 220. For example, with three values referred to as 1, 2, and 3 and shown as 222, 224, 226, there is associated a waveform 212, 214, 216. As illustrated in FIG. 3, a transmission is shown generally by the numeral 250 and is composed of a number of bits or slices 251 to 256. Each slice 251, 252, 253, 254, 255, 256 of the transmission 250 corresponds to a particular one of the waveforms 210. Accordingly, slice 251 corresponds to the value 1 and has the waveform 212, slice 252 corresponds to the value 2 and has the waveform 214, slice 253 corresponds to the value 3 and has the waveform 216, slice 254 corresponds to the value 2 (waveform 214), slice 255 corresponds to the value 3 (waveform 216), and slice 256 corresponds to the value 1 (waveform 212). The value 0 may be represented as no transmission. It may be seen that by varying the encoding within one slice of the transmission 250, more data may be transmitted than with a binary encoding.

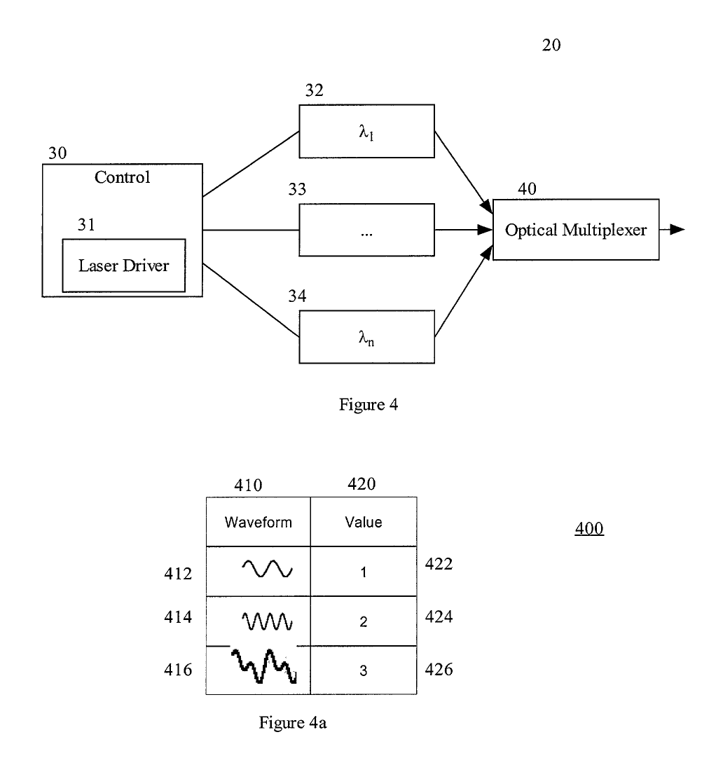

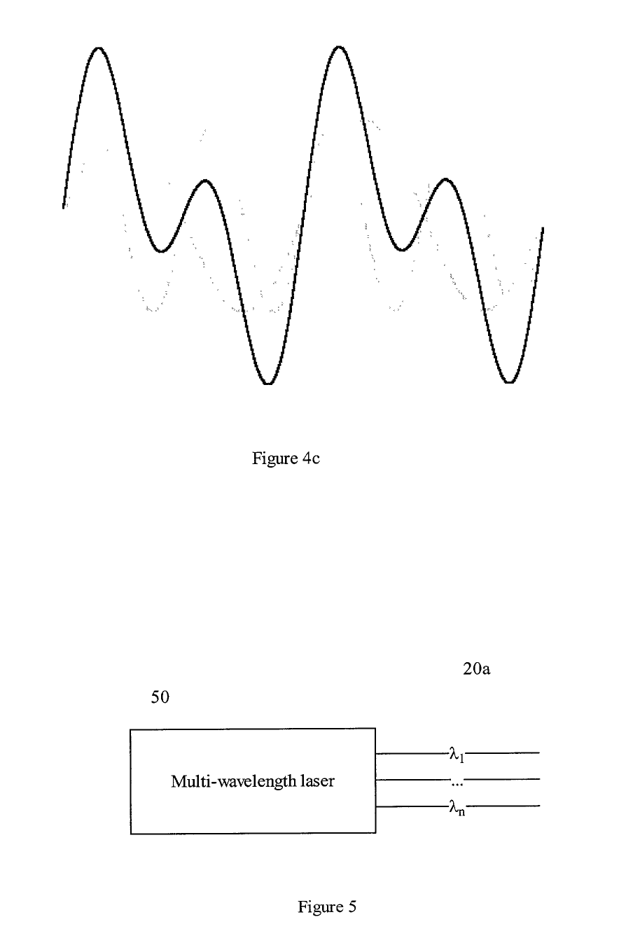

A further embodiment of the optical encoder 20 is shown in FIG. 4. The optical encoder 20 comprises a control 30 with a laser driver 31 which is capable of driving n lasers individually, n lasers 32, 33, 34, and an optical multiplexer 40. Each of the n lasers corresponds to a wavelength λ₁, where i is between 1 and n. In this embodiment, each multi-valued bit has 2ⁿ possible values. Each possible value corresponds to a combination of the n wavelengths. The control 30 operates to choose the appropriate lasers for each multi-valued bit. The laser driver 31 powers the selected lasers simultaneously to generate from each laser a pulse of the appropriate wavelength, which is sent to the optical multiplexer 40 to combine these wavelengths for transmission over the fibre 16. A serial string of slices of the selected waveforms is thus composed for transmission over the fibre 16.

At the destination, a decoder examines the string on a slice by slice basis and determines the value to be accorded to each slice on the basis of the observed optical characteristic.

Referring to FIG. 4a, the nature of the encoding used in the embodiment FIG. 4 is shown generally by numeral 400. A plurality of waveforms 410 are provided, each corresponding to a value 420. In this example, two wavelengths 412, 414 are used, each corresponding to a value 422, 424. As seen in more detail in FIG. 4c, a third waveform 416 is formed as the combination of the wavelengths 412, 414 (shown in a lighter shade) and has a value 426. Referring to FIG. 4b, an exemplary transmission 450 is shown. Each pulse 451, 452, 453, 454, 455, 456 corresponds to one of the waveforms and has the corresponding value.

An alternate embodiment of the optical encoder is shown in FIG. 5 by the numeral 20a. The optical encoder 20a comprises a multi-wavelength laser. It is possible to manufacture multiple lasers on a common substrate with slightly varying energy gap levels by locally varying the doping levels. In this case it is possible to emit three or more wavelengths from a single solid-state device.

By utilising a multi-valued bit coding a significant increase in the transmission rate may be obtained. For example, if a given application necessitates a 32-bit transmission rate using a two-state bit, the same information content can be transmitted using an 8 multi-valued-bit coding technique by using 4 wavelength deep bits consisting of 16 unique states.

Potential reduction of information package width from 32 down to 8 without losing information content provides significant benefits. For a given pulsing rate from a communication laser, there will be a significant savings in the transmission time by moving to multi-valued bit based coding.

Similarly, if the transmission time is held constant, then by using a multi-valued bit based coding, the same information content can be generated at much slower laser pulse rates (hence cheaper, longer life time etc.) from the communication lasers.

As stated earlier, in the multi-valued bit based coding system, each multi-valued bit has many states (i.e. multi-valued bit depth). A given state of a multi-valued bit can be defined by a distinct wavelength, amplitude, a phase characteristic, polarization vector direction or other possible optical characteristics that are generally associated with highly coherent laser pulses.

If various states of a multi-valued bit are defined by only wavelengths, then these wavelengths, which comprise the individual states of a bit, can be obtained as follows:

For the sake of simplicity lets assume that a bit has four distinct states. These can be represented with two wavelengths and a lack of emission, i.e. the zero state for each wavelength. The wavelengths comprising a communication unit can then be split and detected at the other end of the communication fibre by already established techniques and existing DWDM (Dense Wavelength Division Multiplexing) hardware. The extracted signal can be accorded the value associated with that combination of wavelengths.

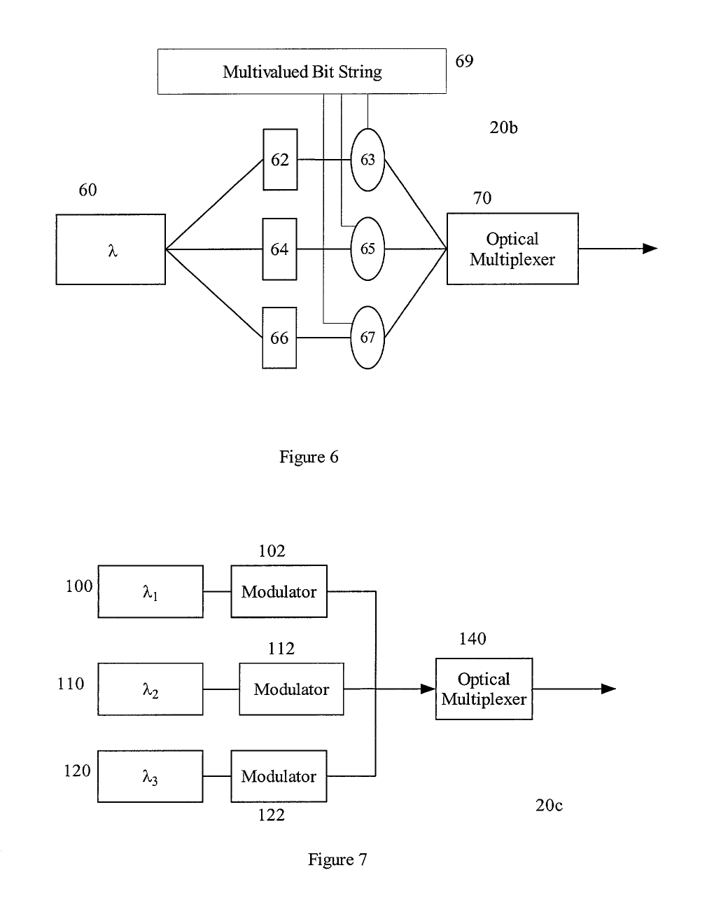

In a further embodiment, the line width (FWHM) of the laser (or the other optical source) is optically separated into a plurality of individual wavelengths with the use of very narrow band pass filters or other similar devices. Referring to FIG. 6, in this embodiment the optical encoder 20b comprises a laser 60, a plurality of very narrow band pass filters 62, 64, 66, a plurality of electronic switches 63, 65, 67, and an optical multiplexer 70. The laser sends a signal of wavelength λ simultaneously to each of the filters 62, 64, 66. In turn the filters transmit to respective ones of the switches switch 63, 65, 67 one of a plurality of wavelengths λ₁, λ₂, . . . , λₙ. The switches are conditioned by a multivalued bit string 69 to be either open or closed so that one combination of wavelengths is provided for each slice. The output of the switches is connected to an optical multiplexer 70 which assembles the received signals into a pulse for transmission over the link 16. In operation, the value of the multivalued-bit determines which switches are activated.

This embodiment is possible if the line width of the laser is adequately broad and the narrow band pass filter transmissions are significantly narrow and do not overlap or if another relatively broad band emitter is used instead of a laser source.

In this embodiment, the laser source can be operated either in the continuous wave mode or in the pulse mode. In the pulse mode operation, the pulsing of the laser needs to be synchronized with the electro-optic switches on individual wavelength branches.

The approaches described above can also be used with the existing DWDM networks where several characteristics such as amplitudes or polarization angles etc. for the bit depth necessary can be established around each DWDM channel. FIG. 7 shows a schematic description of how multi-valued logic can be used in DWDM systems.

Referring therefore to FIG. 7, the optical encoder 20c comprises a plurality of channels 100, 110, 120, a plurality of modulators 102, 112, 122, and an optical multiplexer 140. In FIG. 7 each “channel” of a DWDM is represented by λₓ. The secondary characteristic is embedded onto each channel 100, 110, 120 by the modulator 102, 112, 122. If the secondary characteristic is chosen to be amplitude the generic representation of the modulator will be an amplitude modulator. In this case the signal will be coded in each channel not only in ones and zeros but also in amplitudes. For example, if it is possible to distinguish three distinct amplitude levels at the receiving end of a fiber optic then it will be possible to have four levels of depth for each bit, these being no signal, ⅓ signal level, ⅔ signal level, and full signal.

The modulators in FIG. 7 can also signify optical devices that take advantage of numerous optical characteristics of lasers such as polarization and phase shifts. In case of polarization, modulators can be used take advantage of Birefringence, The Faraday effect, the Kerr effect, and Pockel effects. In case of phase shift wave plates and optical compensators can be used to achieve the desired multi value aspect of a bit.

Furthermore it is also possible to combine the effects such as polarization and phase characteristics with amplitude modification whereby producing a much deeper bit value.

Barry Luther-Davies describes the use of dark spatial solitons for creating optical waveguides (U.S. Pat. No. 5,469,525). In his invention he envisions creating different refractive index channels within certain optical materials in the wake of dark soliton wavefronts and sending communication signals through these temporary channels.

The use of similar techniques provides an additional level of coding to the transmitted signal thereby providing a means to further increase the depth of a multi-valued bit.

It will be recognized that the implementation of multi-valued bit technology over the Internet hardware structure will occur gradually. This means that for a foreseeable future both dual valued and multi valued bit communication will be usedon the Internet hardware side by side. Furthermore the varying sophistication levels of DWDM equipment on the net will limit the n-value of multi-valued bit communication. Therefore there is a need for Base Converter packages on the Internet.

A base converter package reads in any n-valued data and converts it into any other n-base. For example binary data could be converted into base 16 level multi-valued bit data for transmission across the ocean and can then be converted back to binary data for transmission through a metro network.

A multi-valued bit system can be represented as a synchronized parallel transmission of data through an electrical signal network. For example, a four wavelength deep bit (with 16 distinct states) can be transmitted through electrical networks by using four parallel signal lines, if the output signals from these lines are clocked synchronously and the final registers are read and correlated to form one of the possible states of the multi valued bit.

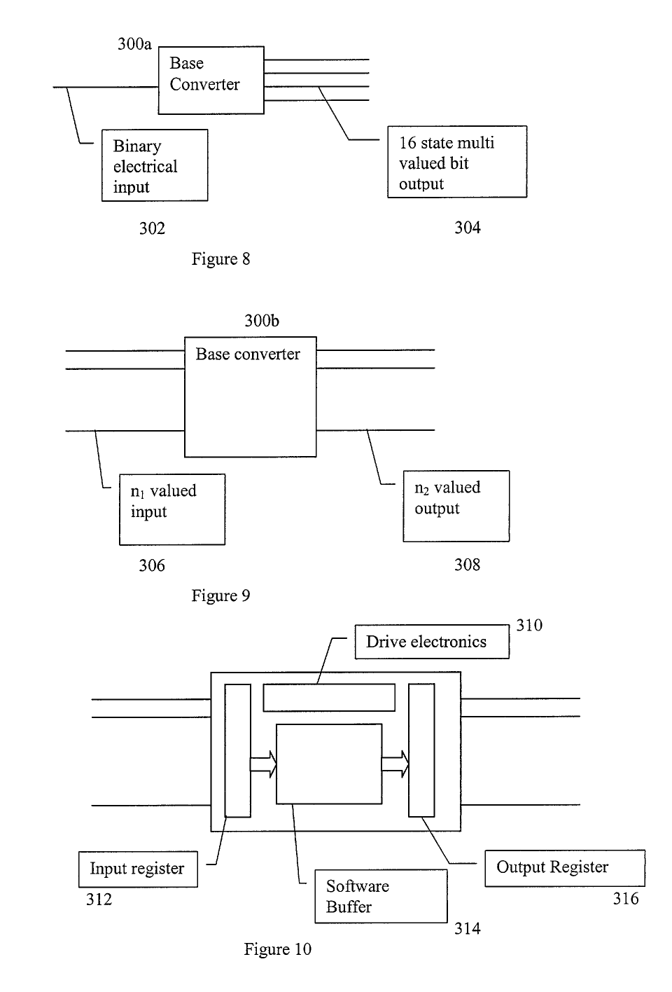

Using this method any given coding scheme can easily be altered to match the capabilities of hardware at hand. Referring to FIG. 8, a base converter 300a is shown connected to binary electrical input 302 and providing 16 state multi-valued bit output 304. Referring to FIG. 9, a more general base converter 300b is connected to n₁ valued input 306 and provides n₂ valued output 308.

The number of input lines and output lines correspond to the bit depth respectively. The number of unique combinations associated with the each multi-valued bit can be calculated using S=2^{b}, where S is the total number of unique combinations available for a given multi-valued bit with a bit depth of “b”. For example in case of a binary bit, b=1 and hence S=2. In the case of a multi valued bit with a bit depth of 4 (b=4) the total number of unique combinations is 16.

The bit depths for the incoming and outgoing lines will be selectable from either hardware dip switches or alternatively through software. Referring to FIG. 10, the base converter 300a, 300b is shown in more detail. The base converter comprises drive electronics 310, an input register 312, a software buffer 314, and an output register 316. In operation, the input register is loaded with a value. The drive electronics use the software buffer to provide the converted value to the output register.

Once the bit depths for the incoming and outgoing lines are established, the following formula links the word lengths for the incoming and out going communication facilities: S₁^{w}=S₂^{w} where S indicates the number of unique states available for the multi-valued bit and its subscripts 1 and 2 indicate incoming and outgoing signals respectively. The superscript w indicates the word length for the incoming and outgoing communications.

Going back to the earlier example of converting a 32 bit binary input to a multivalued bit with n=4 the formula would read: 2³²=16^{w}. This equation can be solved for w to find the equivalent word length for the outgoing communication link. In this instance, w=8.

Though the above description of the base converter is given for electrical input and outputs it is also conceivable to build instruments to achieve the same means purely optically and/or electrooptically.

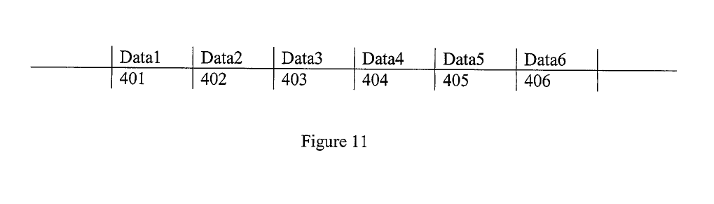

In a further embodiment, a user identifier 400 is added to the communication to provide security. As may be seen in FIG. 11, the user identifier 400 is split into bits 401, 402, 403, 404, 405, 406 and incorporated into the laser pulses Data1, Data2, Data3, Data4, Data5, and Data6. The user identifier bits are sent using one wavelength while the remaining n−1 wavelengths are used for data transmission. When the transmission is recovered by the recipient, the user identifier is obtained and may be used to identify the sender. The complete user identifier is recovered only when the complete message is recovered.

In general, the user identifier should be provided in as many bits are there are pulses in the transmission. However, it is recognized that the user identifier may be any number of bits and may be interspersed into the laser pulses using other techniques that provide a complete recovery of the user identifier only when the complete transmission has been received.

In the multi-valued bit approach to optical communication it is thus possible to assign one of the possible values to a specific function. The increased security comes from the use of one of the registers of each multi-valued bit for a security application only. Therefore if the depth value of the multi-valued bit is n then n−1 registers are used to code the message. The n^{th} channel is used for security or another applications and does not participate in coding the message along with the other n−1 channels. At the demultiplexing stage this information coming from n^{th} specific channel can be resolved as separate information content from the rest of the bit. These sub-channels in turn can be called the “associated security sub-channels” for communication. They can be used by either a central server that is specifically used for Internet security or by the other computer comprising the receiving end of the communication link. Such schemes will be very effective when used with Virtual Private Networks.

Such sub-channels that are integrated into the multi-valued bits can form the backbone of Internet communication in the future where machine-to-machine communication (without human supervision) will be possible. Using such channels information bundles (language ontologies that are associated with semantic web or similar constructs) can be sent between machines.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method of transmitting data over a fibre-optic channel, said data comprising multi-valued bits each having one of at least three possible values, said method comprising:
a) establishing a respective optical characteristic corresponding to each of said possible values;
b) for each multi-valued bit of said data, transmitting a pulse having the optical characteristic corresponding to the value of said multi-valued bit.

2. A method according to claim 1, wherein said optical characteristic comprises wavelength.

3. A method according to claim 2, wherein said optical characteristic further comprises amplitude modification.

4. A method according to claim 1, wherein said optical characteristic comprises polarization.

5. A method according to claim 2, wherein said optical characteristic further comprises amplitude modification.

6. A method according to claim 1, wherein said optical characteristic comprises phase angle.

7. A method according to claim 2, wherein said optical characteristic further comprises amplitude modification.

8. An optical encoder for transmitting data over a fibre-optic channel, said data comprising multi-valued bits each having at least three possible values, said optical encoder comprising:
a) a control;
b) a laser driver operated by said control, and providing a mode corresponding to each of said possible values;
c) at least one laser connected to said laser driver; and
d) an optical multiplexer connected to each of said laser driver;
said control being configured to receive said data, process each multi-valued bit thereof, and operate said laser driver in the mode corresponding to each multi-valued bit of the data and thereby transmit said data.

9. An optical encoder according to claim 8, wherein said at least one laser comprises a laser for each mode, and said laser driver operates in a respective mode by powering the laser corresponding to the respective mode.

10. An optical encoder according to claim 8, wherein said at least one laser provides a wavelength corresponding to each mode, and said laser driver operates in a respective mode by operating the laser at the corresponding wavelength.

11. An optical encoder according to claim 8, further comprising:
a) a plurality of filters coupled to said laser, each of said filters corresponding to a respective mode;
b) a plurality of electronic switches each corresponding to a respective one of the filters; and
c) an optical multiplexer coupled to the switches;
said laser driver operating in a respective mode by operating the switch corresponding to the respective mode to provide a signal corresponding to the respective filter to said optical multiplexer.
